(19) United States
(12) Patent Application Publication
(10) Pub. No.: US 2026/0154053 A1
(43) Pub. Date: Jun. 4, 2026

(54) SYSTEMS AND METHODS FOR SEMANTIC SERVICE DEPLOYMENT

(71) Applicant: CVS Pharmacy, Inc., Woonsocket, RI (US)

(72) Inventors: Victor A. Danilchenko, Woonsocket, RI (US); Jon C. Martin, Woonsocket, RI (US)

(21) Appl. No.: 18/966,621

(22) Filed: Dec. 3, 2024

(51) Int. Cl. G06F 8/60; G06F 8/30; G06F 8/75

(52) U.S. Cl. CPC G06F 8/60; G06F 8/30; G06F 8/75

(57) ABSTRACT

In some instances, a method is provided. The method comprises: deploying a software application within an application deployment computing system using operational code that manages and provisions resources of the application deployment computing system to execute the software application, wherein architectural code is embedded within the operational code and comprises semantic deployments domain-specific language (SDDSL) embeddings that specify cloud resource tags; extracting, from the operational code, the SDDSL embeddings and implicit operational code; rendering the extracted SDDSL embeddings and the implicit operational code to generate an architectural diagram; and displaying the architectural diagram.

### BACKGROUND

When deploying a software application, different types of code may be utilized. For instance, the most commonly known code is application code, which describes the functionality of the software application. For example, the software application may perform one or more tasks and/or functions such as assisting an individual with facilitating their prescription pick-up. The application code may be configured to display screens on a computing device and communicate with an application programming interface (API) to facilitate the prescription pick-up. However, the application code may be incapable of executing the functionalities of the software application by itself. Specifically, the software application may utilize resources from a computing platform (e.g., hardware elements such as servers and/or databases from a cloud computing system) in order to properly execute the functionalities of the software application. For example, the software application may require a repository and/or database to store information such as the individual's log-in information (e.g., account name of the individual). The application code may indicate when the individual should provide their account name (e.g., display a log-in screen on a computing device for the individual to provide their log-in information), but separate code may be used to identify the specific repository from a cloud computing system that stores the log-in information for the software application. This separate code may be and/or include architectural code and/or operational code.

As an example, developing code for a software application may include a plurality of stages such as a high-level stage or design layer stage and an operational stage. At the design layer stage, developers may generate architectural diagrams for the software application that describe the high-level architectural components used by the software application (e.g., the resources of the cloud computing system as well as their connections that are to be used for the software application). Furthermore, the developers may generate code (e.g., operational code) to handle the day-to-day tasks for executing the software application from the resource management perspective (e.g., manage and provision resources to execute the software application). However, it is difficult to recreate the architectural diagram/layout from solely the operational code that handles the day-to-day tasks. Over time, it may be desired to update and modify the software applications, but without the architectural diagrams, this becomes more difficult. In addition, currently, architectural diagrams are maintained manually, but this is: 1) labor-intensive; and 2) the architectural diagrams may diverge from the reality of the architecture as-deployed. Therefore, there remains a technical need to perform semantic service deployments to understand and/or recreate the architectural diagrams from the operational code as well as a technical need to maintain the architectural diagrams automatically and accurately.

### SUMMARY

In some examples, the present application provides a method and system for performing semantic service deployments by embedding architectural code within operational code for a software application. For example, the architectural code may include semantic deployments domain-specific language (SDDSL) embeddings that specify cloud resource tags associated with cloud resources (e.g., hardware elements such as repositories from a cloud computing platform). For instance, during the development phase, a high-level architectural diagram that shows resources of an application deployment computing system (e.g., a cloud computing platform) as well as the connections/links between the resources may be generated and used to develop code for the software application. As mentioned above, the code for the software application may include application code as well as other types of code such as operational code. The developer may embed architectural code (e.g., SDDSL embeddings and/or other architectural code) within the operational code. Afterwards, the software application may be deployed within the application deployment computing system, and the operational code may manage and provision resources of the application deployment computing system to execute the software application.

After a certain amount of time has elapsed, a developer may desire to update the software application. But, without the architectural diagram indicating how the cloud resources are utilized by the software application, including the connections or links between the cloud resources, the developer may have difficulty in updating the software application in an efficient manner. As such, a computing device may extract code (e.g., the architectural code and/or the SDDSL embeddings) for the software application that has been deployed within the application deployment computing system, and use the extracted code to generate the original architectural diagrams. In other words, even after a few years, based solely on the deployed code, the developer may be able to generate the original architectural diagrams that were created during the development phase of the software application. The developer may then use the generated architectural diagrams to prepare new code for updating the software application. Additionally, and/or alternatively, the computing device may extract additional code (e.g., implicit operational code) from the deployed code, and use the implicit operational code as well as the architectural code to generate the architectural diagrams. These examples as well as other examples will be described in further detail below.

In one aspect, a system is provided. The system comprises: a developer computing device and an extraction computing device. The developer computing device is configured to: deploy a software application within an application deployment computing system using operational code that manages and provisions resources of the application deployment computing system to execute the software application, wherein architectural code is embedded within the operational code and comprises semantic deployments domain-specific language (SDDSL) embeddings that specify cloud resource tags. The extraction computing device is configured to: extract, from the operational code, the SDDSL embeddings and implicit operational code; render the extracted SDDSL embeddings and the implicit operational code to generate an architectural diagram; and display the architectural diagram.

Examples may include one of the following features, or any combination thereof. For instance, in some examples, the extraction computing device is further configured to: receive developer input indicating to update the software application based on the generated architectural diagram; generate new and/or modified code for the software application based on the developer input; and redeploy the software application within the application deployment computing system using the new and/or modified code.

In some instances, generating the new and/or modified code for the software application based on the developer input comprises generating new operational code or new SDDSL embeddings for the software application, and wherein redeploying the software application within the application deployment computing system comprises redeploying the software application within the application deployment computing system using the new operational code or the new SDDSL embeddings.

In some variations, generating the new and/or modified code for the software application based on the developer input comprises modifying at least a portion of the operational code or the architectural code that was used to deploy the software application, and wherein redeploying the software application within the application deployment computing system comprises redeploying the software application within the application deployment computing system based on the modification.

In some examples, the system further comprises the application deployment computing system that is configured to: subsequent to deploying the software application, manage the resources of the application deployment computing system to perform one or more functionalities of the software application based on the operational code.

In some instances, the resources of the application deployment computing system comprise one or more web servers, one or more web load balancers, one or more application servers, and one or more application databases, wherein the SDDSL embeddings indicate the resources of the application deployment computing system, and wherein the implicit operational code indicates relationships between a first resource of the application deployment computing system and a second resource of the application deployment computing system.

In some variations, the operational code comprises TERRAFORM script and wherein the architectural diagram is a unified modeling language (UML) diagram.

In some examples, rendering the extracted SDDSL embeddings and the implicit operational code to generate the architectural diagram comprises: rendering the extracted SDDSL embeddings and the implicit operational code using a Plant unified modeling language (PlantUML) renderer to generate PlantUML intermediate code; and generating the UML diagram based on the PlantUML intermediate code.

In some instances, each of the SDDSL embeddings comprises a first entry, a second entry, and a third entry, wherein the first entry indicates a format of the architectural code, the second entry indicates a sub-format of the architectural code, and the third entry indicates a diagram element of the architectural diagram to represent.

In some variations, displaying the architectural diagram comprises displaying hardware elements of the application deployment computing system and dependencies between the hardware elements.

In some examples, the hardware elements comprise containers and objects, and wherein the dependencies comprise link description text and link style between the containers and the objects.

In another aspect, a method is provided. The method comprises: deploying a software application within an application deployment computing system using operational code that manages and provisions resources of the application deployment computing system to execute the software application, wherein architectural code is embedded within the operational code and comprises semantic deployments domain-specific language (SDDSL) embeddings that specify cloud resource tags; extracting, from the operational code, the SDDSL embeddings and implicit operational code; rendering the extracted SDDSL embeddings and the implicit operational code to generate an architectural diagram; and displaying the architectural diagram.

Examples may include one of the following features, or any combination thereof. For instance, in some examples, the method further comprises: receiving developer input indicating to update the software application based on the generated architectural diagram; generating new and/or modified code for the software application based on the developer input; and redeploying the software application within the application deployment computing system using the new and/or modified code.

In some instances, generating the new and/or modified code for the software application based on the developer input comprises generating new operational code or new SDDSL embeddings for the software application, and wherein redeploying the software application within the application deployment computing system comprises redeploying the software application within the application deployment computing system using the new operational code or the new SDDSL embeddings.

In some examples, generating the new and/or modified code for the software application based on the developer input comprises modifying at least a portion of the operational code or the architectural code that was used to deploy the software application, and wherein redeploying the software application within the application deployment computing system comprises redeploying the software application within the application deployment computing system based on the modification.

In some variations, the operational code comprises TERRAFORM script and wherein the architectural diagram is a unified modeling language (UML) diagram.

In some instances, rendering the extracted SDDSL embeddings and the implicit operational code to generate the architectural diagram comprises: rendering the extracted SDDSL embeddings and the implicit operational code using a Plant unified modeling language (PlantUML) renderer to generate PlantUML intermediate code; and generating the UML diagram based on the PlantUML intermediate code.

In some examples, each of the SDDSL embeddings comprises a first entry, a second entry, and a third entry, wherein the first entry indicates a format of the architectural code, the second entry indicates a sub-format of the architectural code, and the third entry indicates a diagram element of the architectural diagram to represent.

In some variations, displaying the architectural diagram comprises displaying hardware elements of the application deployment computing system and dependencies between the hardware elements.

In yet another aspect, a non-transitory computer-readable medium having processor-executable instructions stored thereon is provided. The processor-executable instructions, when executed, facilitate: deploying a software application within an application deployment computing system using operational code that manages and provisions resources of the application deployment computing system to execute the software application, wherein architectural code is embedded within the operational code and comprises semantic deployments domain-specific language (SDDSL) embeddings that specify cloud resource tags; extracting, from the operational code, the SDDSL embeddings and implicit operational code; rendering the extracted SDDSL embeddings and the implicit operational code to generate an architectural diagram; and displaying the architectural diagram.

All examples and features mentioned herein may be combined in any technically possible way.

### BRIEF DESCRIPTION OF THE DRAWINGS

The subject technology will be described in even greater detail below based on the exemplary figures, but is not limited to the examples. All features described and/or illustrated herein can be used alone or combined in different combinations. The features and advantages of various examples will become apparent by reading the following detailed description with reference to the attached drawings which illustrate the following:

FIG. 1 is a simplified block diagram depicting an exemplary computing environment in accordance with one or more examples of the present application.

FIG. 2 is a simplified block diagram of one or more devices or systems within the exemplary environment of FIG. 1.

FIGS. 3A and 3B show an exemplary event sequence for performing semantic service deployment in accordance with one or more examples of the present application.

FIG. 4A shows an example of source code that includes operational code and embedded architectural code in accordance with one or more examples of the present application.

FIG. 4B shows an exemplary architectural diagram that is generated from the source code of FIG. 4A in accordance with one or more examples of the present application.

FIG. 5 is an exemplary process for performing semantic service deployment in accordance with one or more examples of the present application.

### DETAILED DESCRIPTION

Examples of the presented application will now be described more fully hereinafter with reference to the accompanying FIGs., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

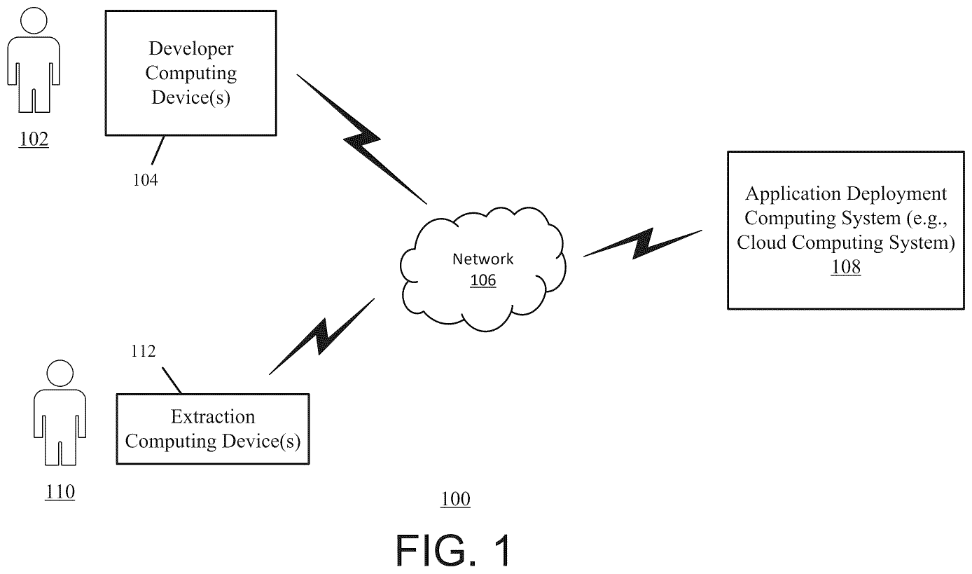

Systems, methods, and computer program products are herein disclosed that perform semantic service deployments. FIG. 1 is a simplified block diagram depicting an exemplary environment in accordance with an example of the present application. The environment 100 includes a first developer 102, one or more developer computing devices 104, a network 106, an application deployment computing system 108 (e.g., a cloud computing system), a second developer 110, and one or more extraction computing devices 112. Although the entities within environment 100 may be described below and/or depicted in the FIGs. as being singular entities, it will be appreciated that the entities and functionalities discussed herein may be implemented by and/or include one or more entities. For instance, the application deployment computing system 108 may include a plurality of computing devices, systems, platforms, repositories, message buses, container orchestration systems, platforms for operating virtual machines (VMs), and/or servers that are spread across multiple different geographical locations and communicate with each other using direct connections and/or the network 106.

The entities within the environment 100 such as the developer computing devices 104, the application deployment computing system 108, and the extraction computing devices 112 may be in communication with other devices and/or systems within the environment 100 via the network 106. The network 106 may be a global area network (GAN) such as the Internet, a wide area network (WAN), a local area network (LAN), or any other type of network or combination of networks. The network 106 may provide a wireline, wireless, or a combination of wireline and wireless communication between the entities within the environment 100

The first developer 102 may be a developer of a software application that is associated with an enterprise organization. The enterprise organization may be any type of corporation, company, organization, and/or other institution that provides one or more goods and/or services. For instance, the enterprise organization may provide multiple different services such as a grocery pick-up service, a prescription pick-up service (e.g., the enterprise organization may provide prescriptions/medications to an individual), an insurance service (e.g., the enterprise organization may provide insurance to an individual), a streaming service (e.g., the enterprise organization may provide for streaming videos, television shows, and so on to an individual), and/or other services.

In some examples, the enterprise organization may seek to develop software applications to provide the goods and/or services to the individuals. As such, the first developer 102, which may be a single developer or a group of developers (e.g., a team), may utilize one or more developer computing devices 104 to develop the software application. For example, as mentioned above, different types of software code may be generated by the first developer 102 for the software application, including application code, architectural code, and/or operational code. Application code may be code that performs the technical or business functions of the application. In some instances, the application code may be software code in C# and/or JAVA. Architectural code may be code that represents the architectural diagrams. In some examples, the architectural code may be in a unified modeling language (UML) or ARCHIMATE language. Operational code may be code that manages the deployment of the application code into its run-time environment. In some variations, the operational code may be in CLOUD FORMATION or TERRAFORM script.

For instance, during an initial stage of development, an architectural diagram indicating resources of a computing platform (e.g., an application deployment computing system 108) to be utilized by the software application may be created. In some instances, the architectural diagram may first be created on an actual whiteboard (e.g., during a team meeting of the first developers 102), and then the developer computing device 104 may generate architectural code indicating the architectural diagram. Following, during another phase of development, the developer computing device 104 may generate operational code indicating how the resources of the computing platform are provisioned and managed for the software application. In other words, whereas the architectural code may indicate the resources themselves and the connections between the resources, the operational code may be at a lower level and indicate how the resources are provisioned and managed. But, without guidance, it may be difficult to recreate the architectural diagram from solely the operational code given that the operational code is at a low-level (e.g., at a software development and information technology (IT) operations (DevOps) level).

Therefore, the first developer 102 may use the developer computing device 104 to embed the architectural code within the operational code prior to deployment of the software application. For example, the developer computing device 104 may obtain input from the first developer 102 and generate source code comprising the operational code and the embedded architectural code based on the input. The architectural code may include semantic deployments domain-specific language (SDDSL) embeddings. Based on the embedded architectural code and certain portions of the operational code (e.g., implicit portions of the operational code or implicit operational code), a computing device (e.g., the developer computing device 104 and/or the extraction computing device 112) may be able to recreate (e.g., generate) the architectural diagram.

In other words, among other advantages, the generated source code may be a concise version of both the architectural code and the operational code. For instance, the ultimate goal of developing a software application is to have ideal code that is as close as possible to pseudo-code (e.g., fake code that facilitates explanation of the function of the code and expresses the concepts of the code in a concise and practical manner). However, actually being able to implement pseudo-code is nearly impossible at this time. Therefore, the developer computing device 104 may seek to generate source code that embeds the architectural code with the SDDSL embeddings within the operational code. Then, the architectural code as well as the implicit operational code may be extracted from the source code, and this intermediate code (e.g., the combination of the explicit SDDSL embeddings and the implicit operational code) may be utilized to infer and/or generate the architectural diagram that was designed during the development phase. As such, by collapsing some of the semantics (e.g., the architectural code) into the same representation as the operational code, the entire architectural code and the entire operational code might not have to be separated out and may be able to be condensed, which leads the combined code to be closer to pseudo-code. Additionally, and/or alternatively, by embedding the architectural code within the operational code, examples of the present disclosure further provide advantages in maintenance, currency, and availability. For instance, by embedding the architectural code within the operational code, the architectural diagram is always current since the architectural diagram is maintained and evolved together with the operational code. In addition, since the architectural code is always with the operational code, the availability is achieved given that there cannot be a loss of access to the architectural diagrams.

The developer computing device(s) 104 are and/or include, but are not limited to, a desktop, laptop, tablet, mobile device (e.g., smartphone device, or other mobile device), smart watch, or any other type of computing device that generally comprises one or more communication components, one or more processing components, and one or more memory components. In some instances, the developer computing device 104 may be a single computing device, and a single developer 102 may use the single computing device to embed the architectural code within the operational code for the software application. In other instances, the developer computing devices 104 may be multiple computing devices, and a team of developers 102 may use the computing devices to embed the architectural code within the operational code for the software application.

After embedding the architectural code into the operational code, the software application may be deployed into the application deployment computing system 108. For instance, the developer computing devices 104 may provide the source code to the application deployment computing system 108, and the application deployment computing system 108 may include resources that are utilized to deploy the software application. Based on the source code (e.g., the operational code with the embedded architectural code), the application deployment computing system 108 may manage, provision, and/or deploy resources (e.g., the web servers, application servers, application databases, message buses, container orchestration systems, platforms for operating VMs, and/or other resources) accordingly. For instance, the application deployment computing system 108 may include and/or be associated with a plurality of hardware elements/components (e.g., resources) such as servers, databases, repositories, load balancers, message buses, container orchestration systems, platforms for operating VMs, and/or other hardware elements. Based on the source code (e.g., the operational code), the application deployment computing system 108 may deploy the resources accordingly to service the software application. For instance, the application deployment computing system 108 may designate one or more servers and/or databases for the operation of the software application in order to service the software application during run-time.

The application deployment computing system 108 includes and/or is implemented using one or more computing devices, computing platforms, cloud computing platforms, systems, servers, databases, repositories, and/or other apparatuses capable of performing semantic service deployment. In some examples, the application deployment computing system 108 may be implemented as engines, software functions, and/or applications. In other words, the functionalities of the application deployment computing system 108 may be implemented as software instructions stored in storage (e.g., memory) and executed by one or more processors.

At a subsequent time, developers (e.g., the first developers 102 and/or the second developers 110) may seek to update the software application. To efficiently and effectively update the software application, the developers may desire to obtain the original architectural diagram that was created during the development phase. As such, the developers may extract the architectural code as well as implicit operational code (e.g., operational code that describes aspects of the architectural diagram such as the connections and/or resources of the architectural diagram) from the source code that was deployed within the application deployment computing system 108.

As such, a computing device (e.g., the developer computing device 104 and/or the extraction computing device 112) may extract intermediate code that includes the architectural code and the implicit operational code from the source code that was deployed within the application deployment computing system 108. The intermediate code may indicate the original architectural diagram. For instance, the computing device may use a renderer to process the intermediate code and generate the architectural diagram. In some variations, the renderer may be and/or include a program such as Plant UML (PlantUML) that processes architectural code such as UML. Subsequently, the developer may use the architectural diagram to prepare new code (e.g., updates) for the software application. For instance, the computing device may obtain new operational code and/or architectural code. Subsequently, the computing device may redeploy the software application based on the new code from the developer.

In some examples, the same team (e.g., the first developers 102) that deployed the software application may continue working on the software application after deployment. As such, the same team may prepare and use the developer computing devices 104 to develop new code and provide updates for the software application.

In other examples, a new developer or a new group of developers (e.g., the second developers 110) may prepare the updates. For instance, programmers and/or developers may move to different teams throughout the life cycle of the software application. While the original group of developers (e.g., the first developers 102) may be aware of the architectural diagram for the software application as they created the architectural diagram during development, another group that begins working on the software application after deployment might not be aware of the architectural diagram. To maintain consistency and facilitate the pass-down process, the embedding of the architectural code within the operational code may be utilized to allow new developers to understand the deployment structure of the software application within the application deployment computing system 108 in an expedited manner. Thus, the new developers may become familiarized with the architectural diagram more rapidly.

As such, in such examples, the second developers 110 may use the extraction computing devices 112 to extract intermediate code (e.g., the architectural code and the implicit operational code) from the source code that was deployed within the application deployment computing system 108. The extraction computing devices 112 may use a renderer to process the extracted code and generate the architectural diagrams. The extraction computing devices 112 may further obtain new code (e.g., new operational code) that includes updates to the software application, and redeploy the software application within the application deployment computing system 108 based on the updates.

The extraction computing device(s) 112 are and/or include, but are not limited to, a desktop, laptop, tablet, mobile device (e.g., smartphone device, or other mobile device), smart watch, an internet of things (IOT) device, or any other type of computing device that generally comprises one or more communication components, one or more processing components, and one or more memory components. In some instances, the extraction computing device 112 may be a single computing device, and a single developer 110 may use the single computing device to generate updates for the software application. In other instances, the extraction computing devices 112 may be multiple computing devices, and a team of developers 110 may use the computing devices to generate the updates for the software application.

It will be appreciated that the exemplary environment depicted in FIG. 1 is merely an example, and that the principles discussed herein may also be applicable to other situations—for example, including other types of institutions, organizations, devices, systems, and network configurations. For example, in some variations, the functionalities of the application deployment computing system 108 may be separated into multiple different entities.

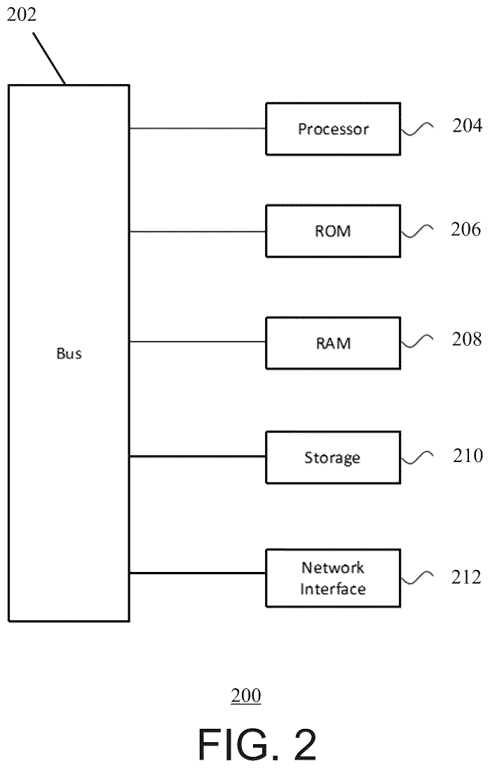

FIG. 2 is a block diagram of an exemplary system and/or device 200 within the environment 100. The device/system 200 includes one or more processors 204, such as one or more CPUs, controller, and/or logic, that executes computer executable instructions for performing the functions, processes, and/or methods described herein. In some examples, the computer executable instructions are locally stored and accessed from a non-transitory computer readable medium, such as storage 210, which may be a hard drive or flash drive. Read Only Memory (ROM) 206 includes computer executable instructions for initializing the processor 204, while the random-access memory (RAM) 208 is the main memory for loading and processing instructions executed by the processor 204. The network interface 212 may connect to a wired network or cellular network and to a local area network or wide area network, such as the network 106. The device/system 200 may also include a bus 202 that connects the processor 204, ROM 206, RAM 208, storage 210, and/or the network interface 212. The components within the device/system 200 may use the bus 202 to communicate with each other. The components within the device/system 200 are merely exemplary and might not be inclusive of every component, server, device, computing platform, and/or computing apparatus within the device/system 200. Additionally, and/or alternatively, the device/system 200 may further include components that might not be included within every entity of environment 100.

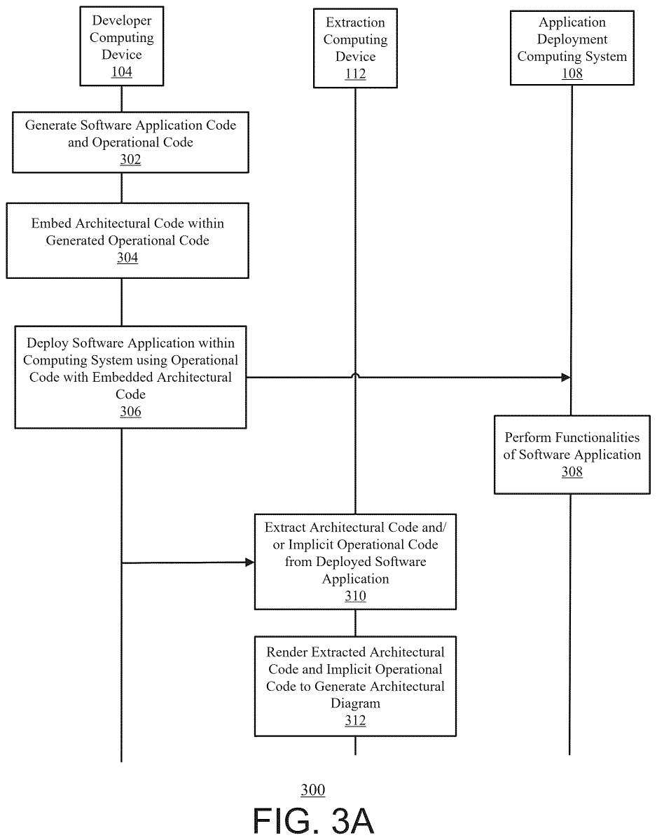

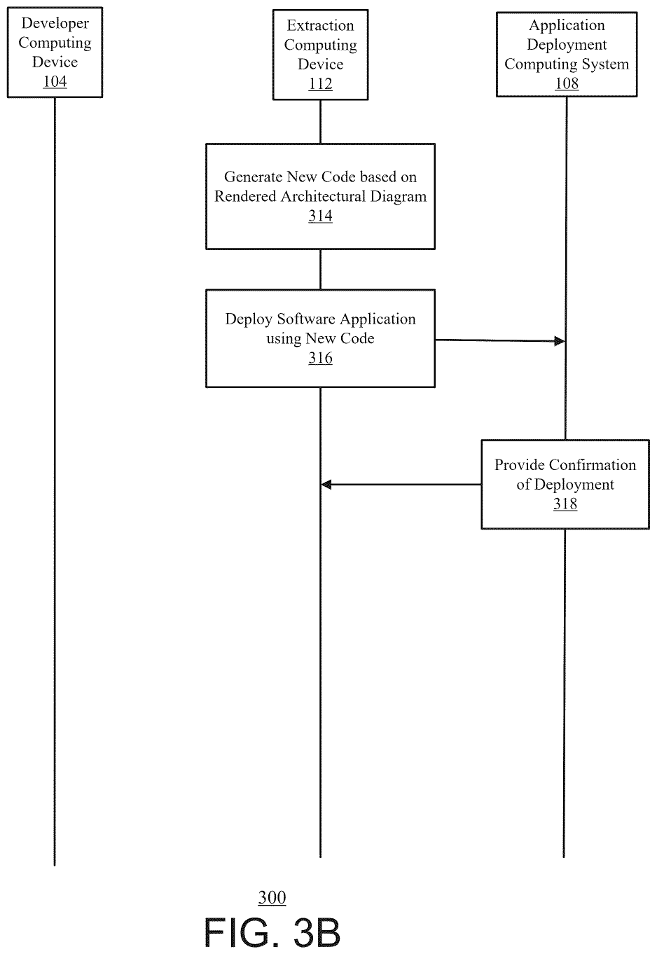

FIGS. 3A and 3B show an exemplary event sequence 300 for performing semantic service deployment in accordance with one or more examples of the present application. However, the event sequence 300 is merely an example and other types of event sequences are contemplated herein including by performing any of the following blocks in any suitable order. The event sequence 300 includes operations, processes, and/or functions that are performed by one or more entities. For example, the event sequence 300 includes blocks performed by the developer computing device 104, the extraction computing device 112, and the application deployment computing system 108, which may be implemented in a cloud environment.

At block 302, the developer computing device 104 generates software application code and operational code. For instance, as mentioned above, a developer (e.g., the first developers 102) may provide input to the developer computing device 104, and the developer computing device 104 may generate different types of code, including application code and operational code, for a software application (e.g., a software application for an enterprise organization that facilitates prescription pick-up).

At block 304, the developer computing device 104 embeds architectural code within the generated operational code. For example, the developer 102 may provide input indicating SDDSL embeddings, and embed the SDDSL embeddings within the generated operational code. The SDDSL embeddings may indicate or specify cloud resource tags (e.g., cloud resource tags associated with servers, databases, repositories, and/or other hardware elements of a cloud computing platform such as the application deployment computing system 108). For example, in some variations, the SDDSL embeddings may be of a particular syntax or data structure, such as a data structure that includes multiple different entries. For instance, a first entry of the SDDSL embeddings may indicate a format (e.g., a particular type of architectural code such as UML). Additionally, and/or alternatively, a second entry of the SDDSL embeddings may indicate sub-format such as “COMPONENT” or “ACTIVITY”, which may be technical terms within the UML such as types of UML diagrams. Additionally, and/or alternatively, a third entry of the SDDSL embeddings may indicate an element to be represented (e.g., a diagram element from an architectural diagram to be represented). For instance, the third entry may be a noun (e.g., a “Name” or “Note” associated with a hardware element such as a server) or a verb (e.g., “Links” or “Contains” associated with connections between the hardware elements of the architectural diagram).

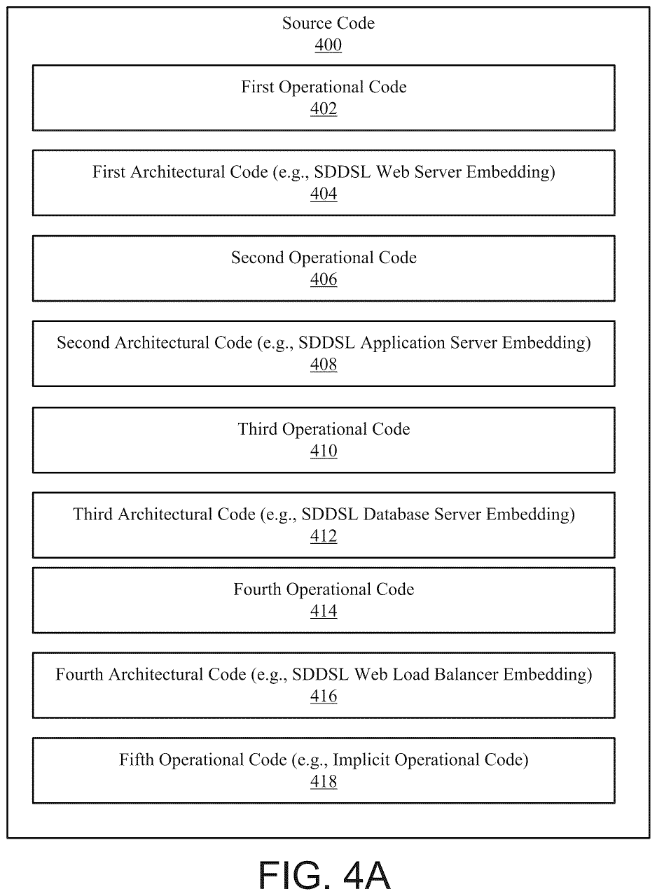

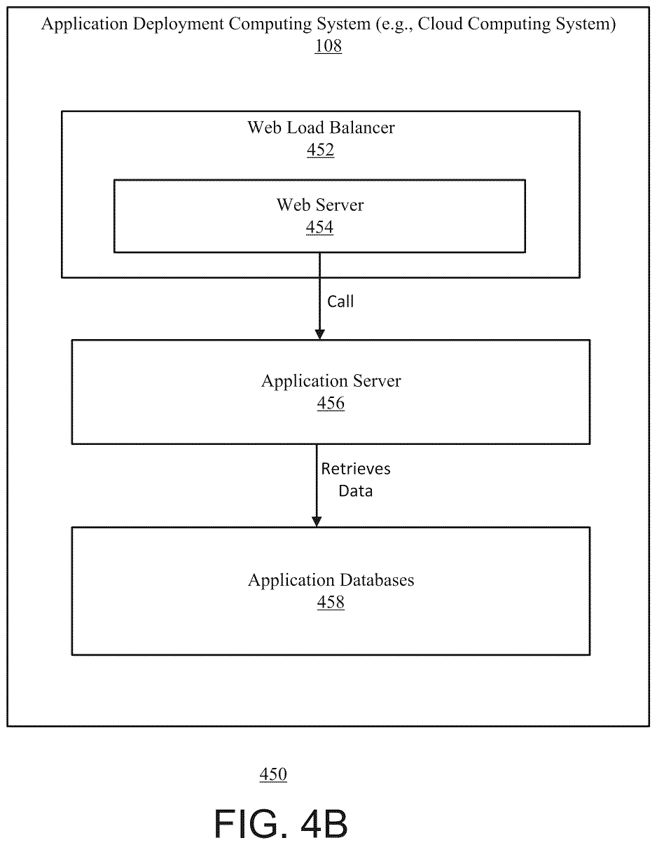

At block 306, after embedding the architectural code within the operational code, the developer computing device 104 deploys the software application within the computing system (e.g., the application deployment computing system 108) using the operational code with the embedded architectural code. The operational code with the embedded architectural code may be a source code for the software application. An example of the source code that comprises the embedding of the architectural code within operational code is shown in FIG. 4A.

FIG. 4A shows an example of source code 400 that includes operational code and embedded architectural code in accordance with one or more examples of the present application. For example, source code 400 may include operational code such as first and second operational code 402 and 406 as well as architectural code such as first and second architectural code 404 and 408. For instance, at block 302, the developer computing device 104 may generate operational code such as the first, second, third, fourth, and fifth operational code 402, 406, 410, 414, and 418. Then, at block 304, the developer computing device 104 may generate and embed architectural code within the generated operational code. For example, the developer computing device 104 may generate the first, second, third, and fourth architectural code 404, 408, 412, and 416 and embed the first, second, third, and fourth architectural code 404, 408, 412, and 416 within the operational code (e.g., the first, second, third, fourth, and fifth operational code 402, 406, 410, 414, and 418). Each of the first, second, third, and fourth architectural code 404, 408, 412, and 416 may indicate cloud resource tags. For instance, the first architectural code 404 may be and/or include SDDSL embeddings for the web server (e.g., SDDSL web server embeddings). Similarly, the second architectural code 408 may be and/or include SDDSL application server embeddings, the third architectural code 412 may be and/or include SDDSL database server embeddings, and the fourth architectural code 416 may be and/or include SDDSL web load balancer embeddings. In addition, as shown, the fifth operational code 418 may be implicit operational code, which may be a portion of the operational code that describes aspects of the architectural diagram such as the connections and/or resources of the architectural diagram. For instance, the fifth operational code 418 may indicate that the web server (e.g., the web server associated with the SDDSL web server embedding from the first architectural code 404) is within the load balancer (e.g., the load balancer associated with the SDDSL load balancer embedding from the fourth architectural code 416). As such, the source code 400 may include architectural code that is embedded within the operational code, and based on the architectural code and portions of the operational code (e.g., the implicit operational code 418), the architectural diagram for the software application may be generated and/or recreated.

The source code 400 shown in FIG. 4A is merely exemplary. For instance, in other examples, the developer computing device 104 may include any number of blocks of operational code (e.g., six, ten, fifty operational code blocks) and any number of blocks of architectural code (e.g., six, ten, fifty architectural code blocks). For example, the source code 400 shown in FIG. 4A may represent a basic three-tier application (e.g., a software application with a web server, application server, and database tiers) with a load balancer. However, in other variations, the software application may be a more complex application that utilizes numerous different resources and/or types of resources that are available within the application deployment computing system 108 such as different types and/or numbers of servers and/or databases that perform different functionalities to properly operate, execute, and/or manage the software application. As such, the developer computing device 104 may embed a number of architectural code blocks into the operational code, and the operational code may include any number of implicit operational code blocks.

Returning back to FIG. 3A, the developer computing device 104 may deploy the software application such as by providing the source code (e.g., the source code 400 that includes the operational code and architectural code) to the application deployment computing system 108. At block 308, the application deployment computing system 108 may perform functionalities of the software application. For instance, based on the operational code (e.g., the first, second, third, fourth, and fifth operational code 402, 406, 410, 414, and 418), the application deployment computing system 108 may deploy its resources (e.g., servers, databases, and/or other hardware elements) to facilitate operations of the software application. For example, in some instances, the software application may be an application to assist individuals in picking-up their prescriptions from a pharmacy. The application deployment system 108 may provide and/or manage resources to perform the functionality of the software application.

At block 310, the extraction computing device 112 extracts architectural code and/or implicit operational code from the deployed software application. For example, as mentioned previously, in some instances, one or more new developers (e.g., a team of second developers 110) may seek to update the already deployed software application. In order to effectively and efficiently update the software application, the new developers may seek to review the architectural diagram prior to preparing new code such as new or modified operational code and/or other code. As such, the new developers may provide input, and the extraction computing device 112 may extract code from the source code of the deployed software application. For instance, the extraction computing device 112 may extract the architectural code and may further extract the implicit operational code. For example, referring to FIG. 4A, the extraction computing device 112 may extract the first, second, third, and fourth architectural code 404, 408, 412, and 416 and may further extract the fifth operational code 418 (e.g., the implicit operational code). In some instances, the extraction computing device 112 may extract the deployed code from the developer computing device 104. For example, the extraction computing device 112 may operate in parallel with the application deployment computing system 108 (e.g., the application deployment computing system 108 may perform functionalities for the software application while the extraction computing device 112 extracts the deployed code for the software application from the developer computing device 104 and uses the extracted code as described below).

At block 312, the extraction computing device 112 renders the extracted architectural code and implicit operational code to generate an architectural diagram. For instance, as mentioned above, the extracted architectural code and implicit operational code may describe an architectural diagram for resources deployed by the application deployment computing system 108 to facilitate operation of the software application. Using a renderer, the extraction computing device 112 may render the extracted architectural code and implicit operational code (e.g., the first, second, third, and fourth architectural code 404, 408, 412, and 416 and the fifth operational code 418) to generate an architectural diagram.

For example, in some variations, the operational code may be in TERRAFORM script and the architectural code may be in UML. The extraction computing device 112 may extract and combine the architectural code and the implicit operational code to obtain an intermediate code such as PlantUML. Following, using a renderer (e.g., a PlantUML renderer), the extraction computing device 112 may generate an architectural diagram such as a UML diagram. FIG. 4B shows an example architectural diagram that may be generated using the source code 400 from FIG. 4A.

FIG. 4B shows an exemplary architectural diagram 450 that is generated from the source code 400 of FIG. 4A in accordance with one or more examples of the present application. For instance, the architectural diagram 450 shows the resources of the application deployment computing system 108 that are used to perform functionalities for the software application. For instance, the architectural diagram 450 includes a web load balancer 452, an application server 456, and application databases 458. Furthermore, the web load balancer 452 includes a web server 454. For example, as mentioned above, the source code 400 included architectural code 404, 408, 412, and 416 that indicated SDDSL embeddings for the web load balancer 452, the web server 454, the application server 456, and the application databases 458. In addition, the SDDSL embeddings for the architectural code 404, 408, 412, and/or 416 may further indicate connections such as the web server 454 is connected to the application server 456 and the application server 456 is connected to the application databases 458. Furthermore, the SDDSL embeddings may indicate links or actions associated with the connections such as the web server 454 “calls” the application server 456 and the application server 456 “retrieves data” from the application databases 458.

In some instances, the architectural diagram 450 shown in FIG. 4B may indicate UML features such as a container (e.g., the load balancer 452 as well as a database from the application databases 458 such as a My Structured Query Language (MySQL) database), an object (e.g., the web server 454, the application server 456, and another database from the application databases 458), and link dependencies (e.g., link description text such as “call” or “retrieves data” and link styles such as defaults and/or dashes).

As mentioned previously, the source code 400 is merely exemplary and thus, the architectural diagram 450 is merely exemplary as well. In other examples, based on the source code 400, the architectural code, and/or the implicit operational code, the architectural diagrams that are rendered by the extraction computing device 112 may be more complex and may include additional and/or alternative resources that are within the application deployment computing system 108. In addition, the operational code being in TERRAFORM script, the architectural code being in UML, and the intermediate code being in PlantUML is merely exemplary and in other examples, the operational code, the architectural code, and/or the intermediate code may be in other software languages and/or representations such as in an ARCHIMATE modeling language.

Referring to FIG. 3B, at block 314, the extraction computing device 112 generates new code based on the rendered architectural diagram. For instance, in some examples, the extraction computing device 112 may modify the extracted code including the extracted architectural code and/or the implicit operational code. Additionally, and/or alternatively, the extraction computing device 112 may extract additional code for the software application from the application deployment computing system 108 (e.g., extract additional operational code such as the second operational code 406). The extraction computing device 112 may modify the extracted additional code (e.g., modify the second operational code 406). Additionally, and/or alternatively, the extraction computing device 112 may generate new code (e.g., new operational code and/or new architectural code). Additionally, and/or alternatively, the extraction computing device 112 may delete or discard code (e.g., discard the third operational code 410) from the source code for the software application. As such, at block 314, the extraction computing device 112 may generate new code based on modifying the extracted architectural and/or implicit operational code, modifying additional code from the software application (e.g., the second operational code 406), generating new code, and/or discarding source code. In some instances, the new code may be a new block of operational code, implicit operational code, and/or architectural code (e.g., new SDDSL embeddings for new resources of the architectural diagram). In other instances, the new code may be a modified version of a previous block of code (e.g., a modified version of the operational code, implicit operational code, and/or architectural code that was previously within the source code).

At block 316, the extraction computing device 112 may deploy the software application using the new code that was generated at block 314. For instance, the extraction computing device 112 may redeploy the software application within the application deployment computing system 108. At block 318, the application deployment computing system 108 may provide a confirmation of deployment to the extraction computing device 112. In other words, at blocks 310-316, the second developers may decide to update the software application. As such, the extraction computing device 112 may extract architectural code and/or implicit operational code, and render the extracted code to generate an architectural diagram. Using the architectural diagram, the second developers may create new code for the software application (e.g., a new update for the software application). The extraction computing device 112 may deploy the software application using the new code (e.g., a new version of the software application with the update), and may receive a confirmation of deployment from the application deployment computing system 108.

As mentioned above, in some instances, a new group of developers using a new computing device (e.g., the extraction computing device 112) may provide the updates. In other instances, the same computing device that first deployed the software application may deploy updates for the software application. In such instances, one or more blocks from event sequence 300 such as blocks 310-316 may be performed by the developer computing device 104.

Example architectural code and implicit operational code from source code 400 is provided below. However, as mentioned previously, the source code 400 as well as its architectural and operational code are merely exemplary.

The first architectural code 404 may include:
SDDSL:UML:COMPONENT:Name=“Web Server”
SDDSL:UML:COMPONENT:Links=“Application Server: call”

The second architectural code 408 may include:
SDDSL:UML:COMPONENT:Name=“Application server”
SDDSL:UML:COMPONENT:Links=“example_db: retrieve data”

The third architectural code 412 may include:
SDDSL:UML:COMPONENT:Name=“DB server”

The fourth architectural code 416 may include:
SDDSL:UML:COMPONENT:ID=“wlb”
SDDSL: UML:COMPONENT:Name:cloud=“Web load balancer”
SDDSL: UML:COMPONENT:Contains=“Web Server”
SDDSL: UML:COMPONENT:LinkedBy:dash=“User”
SDDSL: UML:COMPONENT:Note:Right=“This is a web server\nload balancer”

The implicit operational code 418 may include:
resource “csp_lb_target_group_attachment” “web-attachment” {
target_group_arn=csp_lb_target_group. web_lb.arn
target_id=csp_instance. web_server. id
port=80
}

After extracting the architectural code and the implicit operational code, the extraction computing device 112 may generate intermediate code, which is represented below:
@startuml
cloud “Web load balancer” as wlb {
[Web server]
}
[Application server]
database “MySql” {
[example_db]
}
User . . . >wlb
[Web server]-->[Application server]: call
[Application server]-->[example_db]: retrieve data
note right of [wlb]: This is a web server\nload balancer
@enduml

Based on the intermediate code (e.g., UML intermediate code), the extraction computing device 112 may generate the architectural diagram such as the architectural diagram 450 shown in FIG. 4B.

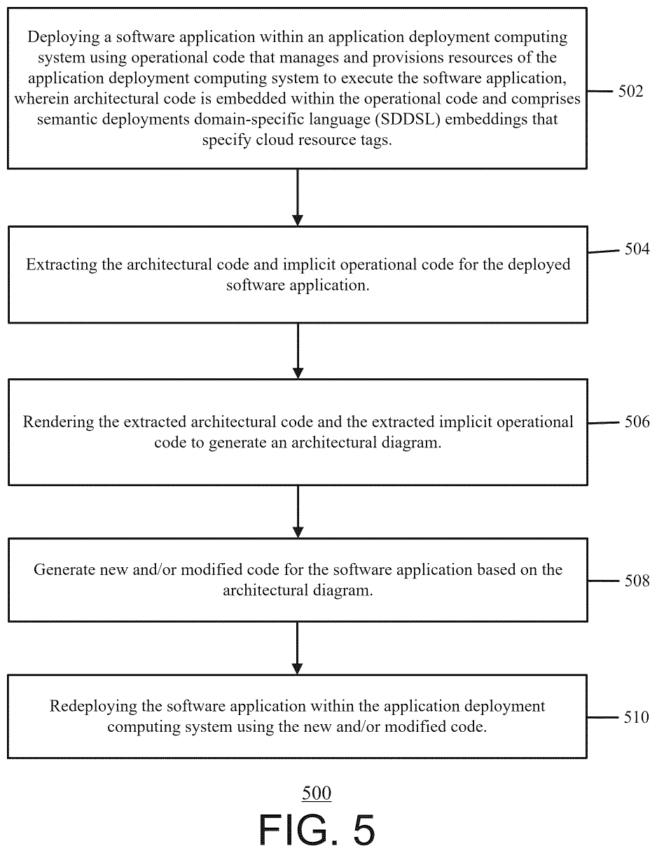

FIG. 5 is an exemplary process for performing semantic service deployment in accordance with one or more examples of the present application. One or more blocks from process 500 may be performed by one or more entities of the environment 100 shown in FIG. 1. It will be recognized that any of the following blocks may be performed in any suitable order, and that the process 500 may be performed in any suitable environment. The descriptions, illustrations, and processes of FIG. 5 are merely exemplary and the process 500 may use other descriptions, illustrations, and processes for performing semantic service deployment.

At block 502, a computing device (e.g., the developer computing device 104) deploys a software application within an application deployment computing system 108 using operational code that manages and provisions resources of the application deployment computing system to execute the software application. Further, architectural code is embedded within the operational code and comprises SDDSL embeddings that specify cloud resource tags. For instance, as described above in blocks 300-306 of the event sequence 300, the developer computing device 104 may generate software application code and operational code, embed architectural code within the generated operational code, and deploy the software application within the computing system using the operational code with the embedded architectural code.

At block 504, a computing device (e.g., the extraction computing device 112) extracts the architectural code and the implicit operational code for the deployed software application. For instance, in some examples, the application deployment computing system 108 may perform functionality for the software application in parallel to updating the software application. In such examples, the computing device, which may be the extraction computing device 112, may extract the architectural code and the implicit operational code from the developer computing device 104. This is described in further detail in block 310 of the event sequence 300.

At block 506, a computing device (e.g., the extraction computing device 112) renders the extracted architectural code and the extracted implicit operational code to generate an architectural diagram. This is described in further detail in block 312 of the event sequence 300.

At block 508, a computing device (e.g., the extraction computing device 112) generates new and/or modified code for the software application based on the architectural diagram. This is described in further detail in block 314 of the event sequence 300.

At block 510, a computing device (e.g., the extraction computing device 112) redeploys the software application within the application deployment computing system 108 using the new and/or modified code. This is described in further detail in block 316 of the event sequence 300.

In some variations and as explained above, the developer computing device 104 may perform one or more blocks of process 500, including all of the blocks of process 500. For instance, the extraction computing device 112 may be and/or include an architectural code processor that renders the extracted code. Thus, at block 506, the developer computing device 104 may generate the architectural diagram based on providing the extracted code (e.g., the extracted architectural and/or implicit operational code) to the extraction computing device 112. The extraction computing device 112 may process the provided code to generate the architectural diagram, and provide the generated architectural diagram back to the developer computing device 104. The developer computing device 104 may then perform blocks 508 and 510 to generate new and/or modified code, and redeploy the software application.

A number of implementations have been described. Nevertheless, it will be understood that additional modifications may be made without departing from the scope of the inventive concepts described herein, and, accordingly, other examples are within the scope of the following claims. For example, it will be appreciated that the examples of the application described herein are merely exemplary. Variations of these examples may become apparent to those of ordinary skill in the art upon reading the foregoing description. The inventor expects skilled artisans to employ such variations as appropriate, and the inventor intends for the application to be practiced otherwise than as specifically described herein. Accordingly, this application includes all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

It will further be appreciated by those of skill in the art that the execution of the various machine-implemented processes and steps described herein may occur via the computerized execution of processor-executable instructions stored on a non-transitory computer-readable medium, e.g., random access memory (RAM), read-only memory (ROM), programmable read-only memory (PROM), volatile, nonvolatile, or other electronic memory mechanism. Thus, for example, the operations described herein as being performed by computing devices and/or components thereof may be carried out by according to processor-executable instructions and/or installed applications corresponding to software, firmware, and/or computer hardware.

The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the application and does not pose a limitation on the scope of the application unless otherwise claimed. No language in the specification should be construed as indicating any non-claimed element as essential to the practice of the application.

1. A system, comprising:
a developer computing device configured to:
deploy a software application within an application deployment computing system using operational code that manages and provisions resources of the application deployment computing system to execute the software application, wherein architectural code is embedded within the operational code and comprises semantic deployments domain-specific language (SDDSL) embeddings that specify cloud resource tags;
an extraction computing device configured to:
extract, from the operational code, the SDDSL embeddings and implicit operational code;
render the extracted SDDSL embeddings and the implicit operational code to generate an architectural diagram; and
display the architectural diagram.

2. The system of claim 1, wherein the extraction computing device is further configured to:
receive developer input indicating to update the software application based on the generated architectural diagram;
generate new and/or modified code for the software application based on the developer input; and
redeploy the software application within the application deployment computing system using the new and/or modified code.

3. The system of claim 2, wherein generating the new and/or modified code for the software application based on the developer input comprises generating new operational code or new SDDSL embeddings for the software application, and wherein redeploying the software application within the application deployment computing system comprises redeploying the software application within the application deployment computing system using the new operational code or the new SDDSL embeddings.

4. The system of claim 2, wherein generating the new and/or modified code for the software application based on the developer input comprises modifying at least a portion of the operational code or the architectural code that was used to deploy the software application, and wherein redeploying the software application within the application deployment computing system comprises redeploying the software application within the application deployment computing system based on the modification.

5. The system of claim 1, further comprising:
the application deployment computing system, wherein the application deployment computing system is configured to:
subsequent to deploying the software application, manage the resources of the application deployment computing system to perform one or more functionalities of the software application based on the operational code.

6. The system of claim 5, wherein the resources of the application deployment computing system comprise one or more web servers, one or more web load balancers, one or more application servers, and one or more application databases, wherein the SDDSL embeddings indicate the resources of the application deployment computing system, and wherein the implicit operational code indicates relationships between a first resource of the application deployment computing system and a second resource of the application deployment computing system.

7. The system of claim 1, wherein the operational code comprises TERRAFORM script and wherein the architectural diagram is a unified modeling language (UML) diagram.

8. The system of claim 7, wherein rendering the extracted SDDSL embeddings and the implicit operational code to generate the architectural diagram comprises:
rendering the extracted SDDSL embeddings and the implicit operational code using a Plant unified modeling language (PlantUML) renderer to generate PlantUML intermediate code; and
generating the UML diagram based on the PlantUML intermediate code.

9. The system of claim 1, wherein each of the SDDSL embeddings comprises a first entry, a second entry, and a third entry, wherein the first entry indicates a format of the architectural code, the second entry indicates a sub-format of the architectural code, and the third entry indicates a diagram element of the architectural diagram to represent.

10. The system of claim 1, wherein displaying the architectural diagram comprises displaying hardware elements of the application deployment computing system and dependencies between the hardware elements.

11. The system of claim 10, wherein the hardware elements comprise containers and objects, and wherein the dependencies comprise link description text and link style between the containers and the objects.

12. A method, comprising:
deploying a software application within an application deployment computing system using operational code that manages and provisions resources of the application deployment computing system to execute the software application, wherein architectural code is embedded within the operational code and comprises semantic deployments domain-specific language (SDDSL) embeddings that specify cloud resource tags;
extracting, from the operational code, the SDDSL embeddings and implicit operational code;
rendering the extracted SDDSL embeddings and the implicit operational code to generate an architectural diagram; and
displaying the architectural diagram.

13. The method of claim 12, further comprising:
receiving developer input indicating to update the software application based on the generated architectural diagram;
generating new and/or modified code for the software application based on the developer input; and
redeploying the software application within the application deployment computing system using the new and/or modified code.

14. The method of claim 13, wherein generating the new and/or modified code for the software application based on the developer input comprises generating new operational code or new SDDSL embeddings for the software application, and wherein redeploying the software application within the application deployment computing system comprises redeploying the software application within the application deployment computing system using the new operational code or the new SDDSL embeddings.

15. The method of claim 13, wherein generating the new and/or modified code for the software application based on the developer input comprises modifying at least a portion of the operational code or the architectural code that was used to deploy the software application, and wherein redeploying the software application within the application deployment computing system comprises redeploying the software application within the application deployment computing system based on the modification.

16. The method of claim 12, wherein the operational code comprises TERRAFORM script and wherein the architectural diagram is a unified modeling language (UML) diagram.

17. The method of claim 16, wherein rendering the extracted SDDSL embeddings and the implicit operational code to generate the architectural diagram comprises:
rendering the extracted SDDSL embeddings and the implicit operational code using a Plant unified modeling language (PlantUML) renderer to generate PlantUML intermediate code; and
generating the UML diagram based on the PlantUML intermediate code.

18. The method of claim 12, wherein each of the SDDSL embeddings comprises a first entry, a second entry, and a third entry, wherein the first entry indicates a format of the architectural code, the second entry indicates a sub-format of the architectural code, and the third entry indicates a diagram element of the architectural diagram to represent.

19. The method of claim 12, wherein displaying the architectural diagram comprises displaying hardware elements of the application deployment computing system and dependencies between the hardware elements.

20. A non-transitory computer-readable medium having processor-executable instructions stored thereon, wherein the processor-executable instructions, when executed, facilitate:
deploying a software application within an application deployment computing system using operational code that manages and provisions resources of the application deployment computing system to execute the software application, wherein architectural code is embedded within the operational code and comprises semantic deployments domain-specific language (SDDSL) embeddings that specify cloud resource tags;
extracting, from the operational code, the SDDSL embeddings and implicit operational code;
rendering the extracted SDDSL embeddings and the implicit operational code to generate an architectural diagram; and
displaying the architectural diagram.
